(19) United States
(12) Patent Application Publication
(10) Pub. No.: US 2006/0278477 A1
(43) Pub. Date: Dec. 14, 2006

(54) Electromechanically-operated parking brake

(75) Inventors: Jürgen Balz, Hunstetten-Oberlibbach (DE); Rolf Weiler, Eppstein (DE); Stefan Johannes Schmitt, Eltville (DE); Andreas Pohlmann, Eschborn (DE); Sebastian Salzmann, Maintal (DE)

Correspondence Address: Craig Hallacher;Continential teves Inc, One Continental Drive, Auburn Hills, MI, 48326, US

(73) Assignee: Continental Teves AG & Co., oHG

(21) Appl. No.: 10/540,165

(22) PCT Filed: Dec. 10, 2003
(86) PCT No.: PCT/EP03/13997

§ 371 Date: Jul. 3, 2006

(30) Foreign Application Priority Data
Dec. 20, 2002 (DE) 102 61 095.9
Sep. 17, 2003 (DE) 103 43 246.9

(51) Int. Cl. F16D 65/36

(52) U.S. Cl. 188/156

(57) ABSTRACT

The present device relates to an electromechanically operated parking brake for motor vehicles that is designed as a drum brake of the ‘Duo-Servo’ type, including a floatingly supported expanding lock which is operable by an electromechanical actuator arranged on a wheel support member and which acts on two brake shoes. To ensure the floating support of the expanding lock that is formed of a threaded-nut/spindle assembly and to always provide a desired application force, the invention discloses that the threaded nut on its outside circumference has a spur toothing which forms a spiral-toothed gear wheel system along with a spiral-toothed gear wheel driven by the electromechanical actuator.

### BACKGROUND OF THE INVENTION

The present invention relates to an electromechanically operated parking brake for motor vehicles that is designed as a drum brake of the ‘Duo-Servo’ type, including a floatingly supported expanding lock which is operable by an electromechanical actuator arranged on a wheel carrier and which acts on two brake shoes.

German published application DE 198 46 420 A1 discloses a drum brake which performs the function of a drum brake of the ‘Simplex’ type during service brake operations, while it performs the function of a drum brake of the ‘Duo-Servo’ type during parking brake operations. To this end the prior-art drum brake is equipped with an electromechanically operable device eliminating the effect of the supporting device of the two brake shoes and achieving a floating support. This measure causes the brake shoes to move into simultaneous engagement with the brake drum in order to carry out a parking brake operation. It is inadvantageous in the prior art drum brake that the brake shoes can only be readjusted by one single predefined distance during a parking brake operation which is not sufficient to achieve the necessary application force, especially when the brake pads are worn out.

In view of the above, an object of the invention involves improving an electromechanically operated parking brake of the type mentioned hereinabove to such an end that the application force is reliably provided during a parking brake operation even if the brake pads are worn out.

### SUMMARY OF THE INVENTION

According to the invention, this object is achieved in that the expanding lock is formed of a threaded-nut/spindle assembly and the threaded nut thereof is driven by the electromechanical actuator.

A favorable improvement of the object of the invention provides that the threaded nut has a spur toothing that forms a skew gear system in conjunction with a spiral-toothed gear wheel driven by the electromechanical actuator.

In another favorable improvement of the object of the invention, the threaded nut includes a spur toothing that forms a spur gear system in conjunction with a gear wheel driven by the electromechanical actuator.

Arrangements have been made that the electromechanical actuator is fitted radially to the brake drum at an angle adapted to the existing mounting space relative to a plane that is perpendicular to the axis of the brake drum.

The electromechanical actuator is mounted tangentially relative to the brake drum in a favorable improvement.

Further, a reduction gear is interposed between the electromechanical actuator and the spiral-toothed gear wheel or the gear wheel, respectively.

It is especially favorable in this case when the threaded-nut/spindle assembly or the reduction gear has a self-locking design.

In a particularly favorable improvement of the object of the invention, the electromechanical actuator is an electric motor that includes a sensor for sensing the position of its rotor. This measure allows determining the pad wear of the brake shoes.

The brake drum is arranged in the mid-area of a brake disc in another favorable embodiment of the object of the invention.

### BRIEF DESCRIPTION OF THE DRAWINGS

The invention will be explained in detail in the following by way of two embodiments making reference to the accompanying drawings. In the drawings,

FIG. 1 is a simplified view of a first embodiment of the parking brake of the invention.

FIG. 2 is a cross-sectional view of an expanding lock which can be mounted into the parking brake illustrated in FIG. 1.

FIGS. 3a,b show in a schematic perspective representation a second embodiment of the parking brake of the invention in a rear and front view.

FIG. 4 is a sectional view of an expanding lock which can be mounted into the parking brake illustrated in FIG. 3.

### DETAILED DESCRIPTION OF THE DRAWINGS

The electromechanically operated parking brake of the invention, as shown in the drawings, essentially comprises a per se known drum brake of the ‘Duo-Servo’ type and an electromechanical actuator 15. The drum brake of the ‘Duo-Servo’ type includes a brake drum 5, a pair of brake shoes 3, 4 furnished with friction surfaces, and an expanding lock 2 that can move the friction surfaces of the brake shoes 3, 4 into engagement with the inside surface of the brake drum 5. Characteristic of the drum brake of the ‘Duo-Servo’ type is a freely movable or floatingly mounted supporting device 14 which is opposed to the expanding lock 2 and arranged between the brake shoes 3, 4. Further, the supporting device 14 is combined with a readjusting device.

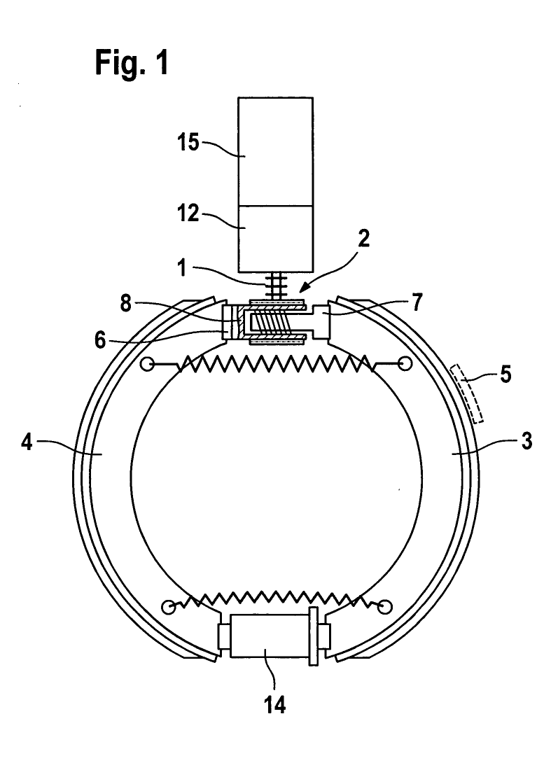

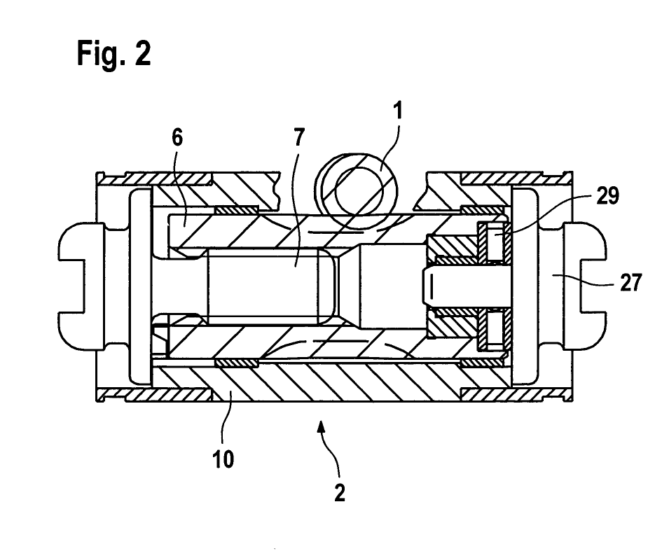

In the first design illustrated in FIG. 1, the electromechanical actuator 15 is fitted radially relative to the brake drum 5 at a wheel carrier (not shown) preferably at an angle of roughly 30° with respect to the illustrated sectional plane, which is especially favorable in terms of the limited mounting space conditions at the wheel. The electromechanical actuator 15 drives a spiral-toothed gear wheel 1 by way of a reduction gear 12 that is not described in detail, with the result that the above-mentioned expanding lock 2 is actuated, which will still be dealt with in detail with reference to FIG. 2. The expanding lock 2 is designed as a threaded-nut/spindle assembly 8 having a threaded nut 6 that includes a toothed system on its outward surface extending in parallel to the axis of the threaded nut 6. With this spur toothing on the threaded nut 6, the above-mentioned spiral-toothed gear wheel 1 forms a skew gear system. The threaded nut 6 is induced to perform a rotational movement when the spiral-toothed gear wheel 1 is actuated by the electromechanical actuator 15. Due to this rotational movement of the threaded nut 6, the spindle 7 of the threaded-nut/spindle assembly 8 performs a translational motion and urges the two brake shoes 3 4 with the desired application force into engagement with the brake drum 5 even if the brake pads are worn out.

In order to carry out a parking brake operation, either the reduction gear 12 or the threaded-nut/spindle assembly 8 has a self-locking design. This measure causes the brake shoes 3, 4 to remain in engagement with the brake drum 5 in the de-energized condition of the electromechanical actuator 15.

The electromechanical actuator 15 mentioned hereinabove is formed of an electric motor and includes a sensor (not shown) that senses the position of its rotor. This fact allows determining how many rotations the rotor and, hence, both the spiral-toothed gear wheel 1 and the threaded nut 6 perform. This information is used to achieve pad wear detection of the brake shoes 3, 4 that operates in a very reliable manner.

The expanding lock 2 will now be explained in detail making reference to FIG. 2. As has been mentioned already, the expanding lock 2 is formed of a threaded-nut/spindle assembly 8 having a threaded nut 6 that is pivoted in a housing 10 of the expanding lock 2 by means of an axial bearing 29. The spur toothing on the outside surface of the threaded nut 6 is shown only schematically, and the spiral-toothed gear wheel 1 engaged with the nut is shown only in cross-section. As soon as the electromechanical actuator drives the spiral-toothed gear wheel 1, the threaded nut 6 will be moved to rotate, as has already been described. As a result, the spindle 7 performs a translational motion to the left, as viewed in the drawing, urging the first brake shoe 3 against the brake drum 5. The application force thereby achieved is supported on a pressure member 27 by way of the axial bearing 29. As a reaction, the second brake shoe 4 is also urged against the brake drum, and the expanding lock 2 centers itself inside the brake drum 5. To permit the previously described action, the expanding lock 2 or the threaded-nut/spindle assembly 8, respectively, must be mounted in a freely movable, that means floating manner. For this reason, the axis of the electromechanical actuator 15 or of the spiral-toothed gear wheel 1, respectively, does not form a right angle with the axis of the spur-toothed threaded nut 6 but is offset in angles corresponding to the pitch of the spiral-toothed gear wheel 1. This offset of angles renders it possible that the entire inside area of the expanding lock 2 is axially displaceable in the housing 10. This allows compensating the clearances within the brake drum 5.

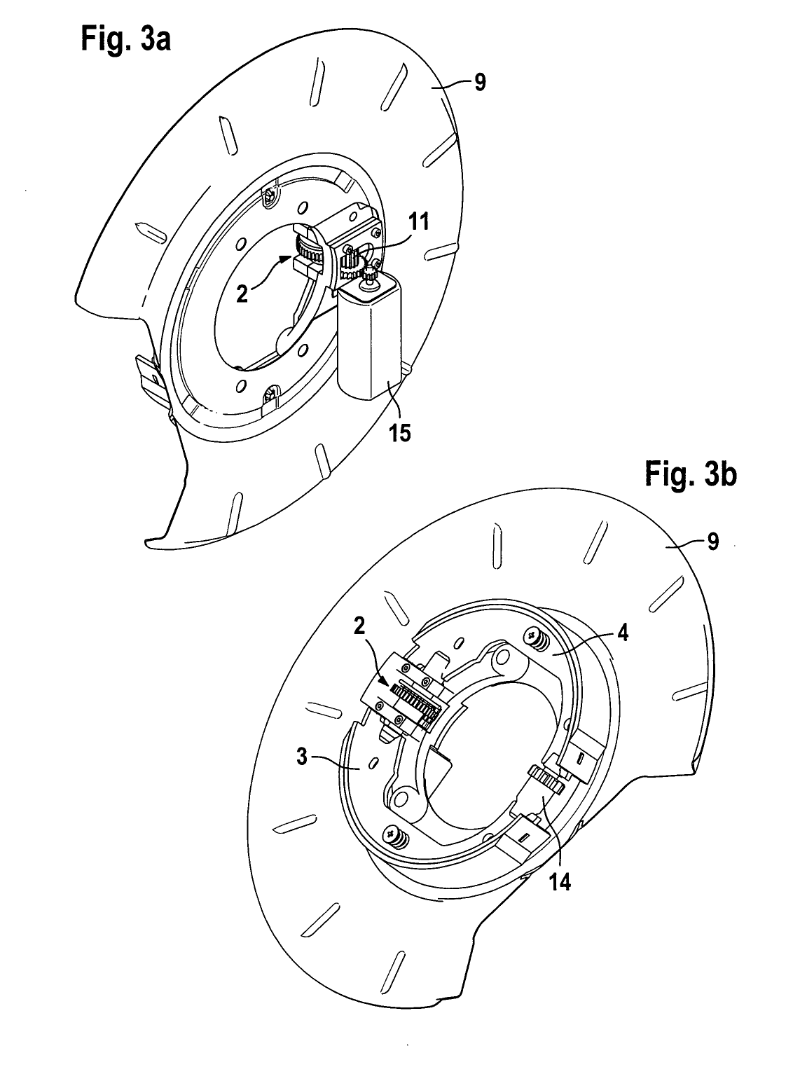

In the second design of the parking brake of the invention illustrated in FIG. 3a and FIG. 3b, the electromechanical actuator 15 is mounted tangentially relative to the brake drum 5 on a mud guard 9 which, in turn, is rigidly connected to the wheel carrier (not shown). This arrangement of the electromechanical actuator 15 is also advantageous in view of the limited mounting space conditions at the wheel.

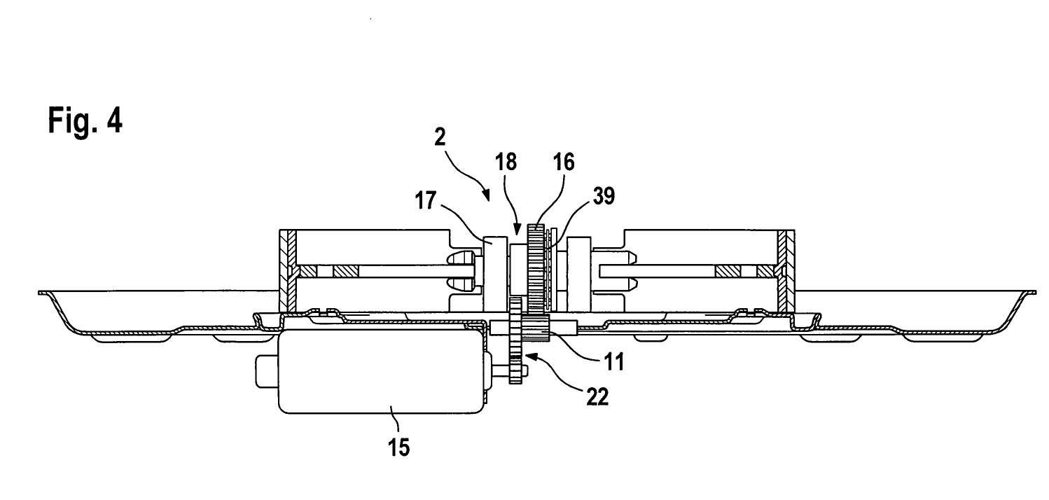

The electromechanical actuator 15 drives a gear wheel 11 by way of a reduction gear 22, whereby the expanding lock 2 is actuated and the two brake shoes 3, 4 are moved into engagement with the inside surface of the brake drum 5. The expanding lock 2 in turn is formed of a threaded-nut/spindle assembly 18, as has been illustrated in FIG. 4 in particular. The threaded nut 16 has a spur toothing on its outside surface and forms a spur-toothed gear system along with the gear wheel 11. As soon as the electromechanical actuator 15 drives the gear wheel 11 by way of the reduction gear 22, the threaded nut 16 is moved to rotate, whereupon the spindle 17 performs a translational motion, urging the brake shoe 3 associated with spindle 17 against the brake drum 5. As a reaction, the other brake shoe 4 is also urged against the brake drum 5, and the expanding lock 2 centers itself. The floating support of the expanding lock 2 that is necessary for this operation is achieved in that the gear wheel 11 with the threaded nut 16 forms a spur-toothed gear system and the gear wheel 11 has a broader design than the spur toothing at the outside periphery of the threaded nut 16. This renders the threaded-nut/spindle assembly 18 to be freely movable in a horizontal direction, what can be seen in FIG. 4 in particular.

To be able to perform a parking brake operation, the reduction gear 22 of the threaded-nut/spindle assembly 18 must have a self-locking design, as is the case in the first design of the parking brake of the invention that has been described with respect to FIG. 1 and FIG. 2, in order that the adjusted application force is maintained after deactivation of the electromechanical actuator 15.

In both described embodiments of the parking brake of the invention, the electromechanical actuator 15 along with the brake shoes 3, 4, the supporting device 14 and the mud guard 9 can form a ready-to-install subassembly which can be mounted in a particularly simple fashion during the manufacture of motor vehicles.

Further, both described embodiments of the parking brake of the invention can be combined with a hydraulic disc brake for service brake operations in that the brake drum 5 is arranged in the mid-area of a brake disc. This is favorable because the parking brake of the invention can be operated by means of a particularly low-cost actuation of the electromechanical actuator 15 and the power requirement of the electromechanical actuator 15 can be minimized.

1-11. (canceled)

12. An electromechanically operated parking brake for motor vehicles, the parking brake comprising:
an electromechanical actuator arranged on a wheel carrier; and
a brake drum having a floatingly supported expanding lock, wherein the brake drum is operable by the electromechanical actuator which acts on two brake shoes, and the expanding lock is formed of a threaded-nut/spindle assembly and a threaded nut thereof is driven by the electromechanical actuator.

13. The electromechanically operated parking brake of claim 12, wherein the threaded nut has a spur toothing that forms a skew gear system in conjunction with a spiral-toothed gear wheel driven by the electromechanical actuator.

14. The electromechanically operated parking brake of claim 13, wherein a reduction gear is interposed between the electromechanical actuator and the spiral-toothed gear wheel.

15. The electromechanically operated parking brake of claim 14, wherein the reduction gear has a self-locking design.

16. The electromechanically operated parking brake of claim 12, wherein the threaded nut includes a spur toothing that forms a spur gear system in conjunction with a gear wheel driven by the electromechanical actuator.

17. The electromechanically operated parking brake of claim 16, wherein a reduction gear is interposed between the electromechanical actuator and the gear wheel.

18. The electromechanically operated parking brake of claim 17, wherein the reduction gear has a self-locking design.

19. The electromechanically operated parking brake of claim 12, wherein the electromechanical actuator is fitted radially relative to the brake drum at an angle adapted to existing mounting space relative to a plane that is perpendicular to the axis of the brake drum.

20. The electromechanically operated parking brake of claim 12, wherein the electromechanical actuator is mounted tangentially relative to the brake drum.

21. The electromechanically operated parking brake of claim 12, wherein the threaded-nut/spindle assembly has a self-locking design.

22. The electromechanically operated parking brake of claim 12, wherein the electromechanical actuator is an electric motor that includes a sensor for sensing the position of its rotor.

23. The electromechanically operated parking brake of claim 12, wherein the brake drum is arranged in a mid-area of a brake disc.
